(19) United States
(12) Patent Application Publication
(10) Pub. No.: US 2024/0265773 A1
(43) Pub. Date: Aug. 8, 2024

(54) System and Method for Preventing Fraud Through Intelligent Matching of Players In Multiplayer Online Gaming

(71) Applicant: Galactus Funware Technology Private Limited, Bengaluru, Karnataka (IN)

(72) Inventors: Ashwin AGRAWAL, Bhopal (IN); Aakansh GUPTA, Faridabad (IN); Rishi SWAMI, Bengaluru (IN); Kabir RUSTOGI, New Delhi (IN)

(21) Appl. No.: 18/549,326

(22) PCT Filed: Jun. 28, 2023
(86) PCT No.: PCT/IB2023/056686

§ 371 Date: Sep. 6, 2023

(30) Foreign Application Priority Data
May 9, 2022 (IN) 202241026757

(51) Int. Cl. G07F 17/32; G06F 18/23

(52) U.S. Cl. CPC G07F 17/3241; G06F 18/23; G07F 17/3237; G07F 17/3274

(57) ABSTRACT

Disclosures of the present invention relate to a system and method for preventing, minimizing and penalizing fraudulent actions by matching players in a unique and intelligent way. The system in the present invention is capable of assessing a player's collusion profile which is indicative of the past and future collusive actions of the player. Through processing of multiple collusion profiles, a cluster of players which have a high probability of colluding within themselves may be identified. By identifying such clusters, the system in the present invention ensures that the probability of colluders to play together in a single instance of a game is reduced/minimized, thereby minimizing the probability of collusive actions.

### FIELD OF INVENTION

Embodiments of the disclosure relate generally to the field of matching players in multiplayer online gaming systems. More particularly, embodiments of the disclosure relate to a method and system for preventing fraud while matching players in multiplayer online gaming.

### BACKGROUND

With the dramatic increase in popularity of online gaming in recent years, the number of players employing various types of cheats, hacks, and exploits have also risen exponentially. One such form of cheating is collusion between players where two or more players co-ordinate their respective playing strategies in order to gain an advantage over the remaining players in the game, thereby destroying the fairness of the game.

Colluders may employ different strategies to gain an upper hand over other players. This is usually done to receive a financial (whether real world or virtual money) reward, or to secure a leaderboard position. In some cases, colluders may also use the gaming platform as a medium to launder money illegally.

During collusion, or by forming alliances, colluders may vary their playing style against their alliance players or against other players. For example, the colluders can engage in soft play and refrain from offensive action against one another, or even lose deliberately in a tournament to enhance co-colluders' position. Or colluders can raise the stakes dramatically in order to force out non-colluding players.

Various techniques have been developed in the past to catch colluding players. For example, non-colluding players may flag or report colluding behaviors in a game. Another way to catch collusion is by detecting anomalies in the game play i.e., detecting collusive behaviour through soft play, forced moves, unusual cautious play etc. Yet another way of detecting collusion is through anti-money laundering measures whereby money deposits and withdrawals are scrutinized for colluding players to confirm presence of collusive actions.

However, majority of the techniques focus on catching the colluders after collusion has taken place or during. As a result, non-colluding players generally feel frustrated and cheated and, in most cases, are tempted to leave the gaming platform, thereby causing revenue and reputation losses.

A need, therefore, arises for a method and system for preventing colluders to take undue advantage of unsuspecting, non-colluding players.

### SUMMARY

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention provides for a method matching players requesting to play a virtual game.

The method comprises of a step of receiving a plurality of matchmaking requests wherein each matchmaking request signals an intent of one player to play the virtual game. Further, for each of the matchmaking requests a participating entity ID is identifies which has made the said matchmaking request.

Further, a collusion profile is accessed for each of the participant entity ID and the plurality of the collusion profiles is processed to identify at least one cluster of participant entity IDs and a plurality of player profiles corresponding to each of a first plurality of the participant entity IDs is also accessed.

Furthermore, the plurality of player profiles to identity a first subset of participant entity IDs, which are proposed to participate in an instance of the game, is processed. The first subset of participant entity IDs as accessed contains no more than one participant entity ID corresponding to the at least one cluster of participant entity IDs.

Further, the present invention provides a system for matching players requesting to play a virtual game. The system of the present invention comprises one or more processing modules; one or more data storage modules. The data storage modules are operatively coupled to the one or more processing modules.

Further, the one or more data storage modules are configured to store at least one of a plurality of participant entity IDs; a plurality of collusion profiles; a plurality of player profile and at least one memory module operatively coupled to the one or more processing modules.

Further, the plurality of collusion profiles corresponds to one participant entity ID from the plurality of participant entity IDs.

Further, the memory module stores instructions which when executed by the one or more processing modules causes the one or more processing modules to identify a plurality of participating entity ID of a plurality of matchmaking requests where each identified participating entity ID corresponds to one matchmaking request.

The system further accesses a plurality of collusion profiles corresponding to the identified participant entity IDs, wherein each collusion profile corresponds to one of the identified participant entity IDs. The system further processes the plurality of collusion profiles to identity at least one cluster of participant entity IDs and accesses a plurality of player profiles corresponding to each of a first plurality of the participant entity IDs;

Further, the system processes the plurality of player profiles to identify a first subset of participant entity IDs, which are proposed to participate in an instance of the game.

Further, the first subset of participant entity IDs contains no more than one participant entity ID corresponding to the at least one cluster of participant entity IDs. It is an object of the invention to provide improved methods for matching players intending to play a multiplayer online game.

It is another object of the invention to provide improved methods for preventing and monitoring collusive action by intelligently matching players intending to play a multiplayer online game.

The independent claims define the invention in various aspects. The dependent claims state selected elements of embodiments according to the invention in various aspects.

This summary is submitted with the understanding that it will not be used to interpret or limit the scope or meaning of the claims. This summary is not intended to identify key features or essential features of the claimed subject matter, nor is it intended to be used as an aid in determining the scope of the claimed subject matter. Other methods, apparatus and systems are also disclosed. Those skilled in the art will recognize additional features and advantages upon reading the following detailed description, and upon viewing the accompanying drawings.

### BRIEF DESCRIPTION OF DRAWINGS

Embodiments according to the claimed subject matter are described below with reference to the drawings. The detailed description references the accompanying figures. The same numbers can be used throughout the drawings to reference like-features and components. As used herein, like terms refer to like elements throughout the description. It should be noted that views of exemplary embodiments are merely to illustrate selected features of the embodiment. The views qualitatively illustrate exemplary features of some embodiments and, therefore, should not be interpreted as being drawn to scale.

FIG. 1 is a block diagram schematically showing an exemplary gaming architecture according to some implementations of the present invention.

FIG. 2 is a block diagram schematically showing an exemplary configuration of the central gaming system 101 according to some implementations of the present invention.

FIG. 3 is a graphical representation of multiple shared segments as shall be explained hereunder.

FIG. 4 is a flowchart illustrating a method of preventing fraud by matching players intelligently.

### DETAILED DESCRIPTION

For purposes of explanation, numerous specific details are set forth in order to provide a thorough understanding of the claimed subject matter. It may be evident, however, that the claimed subject matter may be practiced without these specific details. Also, in some instances, well-known features are omitted or simplified to clarify the description of the exemplary implementations. In some other instances, well-known features or units or circuits have been shown in block diagram form in order to avoid clutter due to unnecessary detailing. Reference will now be made to the drawings to describe the present invention in detail. The implementations herein are described in terms of exemplary embodiments. However, it should be appreciated that individual aspects of the implementations may be separately claimed and one or more of the features of the various embodiments may be combined.

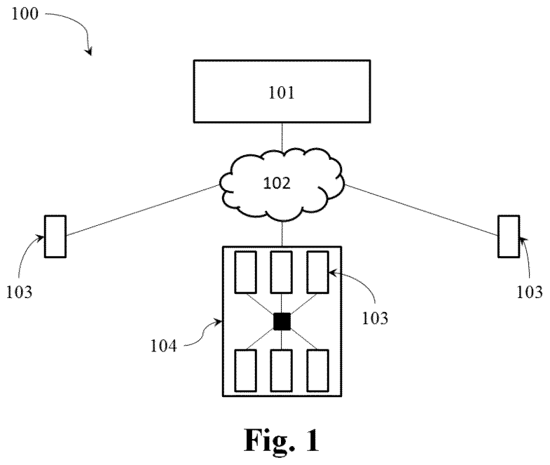

FIG. 1 is a block diagram schematically showing an exemplary gaming architecture according to some implementations of the present invention. The gaming architecture 100 may include a central gaming system 101 and a communications network 102.

The communications network 102 may be any wired and/or wireless network such as internet, WWW, local or wide area network, satellite communication network, Ethernet, PSTN, radio communication network or any such wired and/or wireless communication networks well known in the art. The communications network 102 may also be a combination of such known networks.

The central gaming system 101 may communicate with plurality of gaming terminals through the communications network 102. The gaming terminals may be player terminals 103. Alternatively, or in addition, the gaming terminals may be local gaming systems 104, which are connected, wired or wirelessly, to player terminals 103.

Player terminals 103 may include, but not limited to, mobile phones, desktops, laptops, tablet computers, handheld devices, dedicated gaming consoles, or the like. The local gaming system 104 may facilitate communication between the player terminals 103 and the central gaming system 101. Alternatively, or in addition, the local gaming systems 104 may administer the games, track game data, player data, regulations data, track or manage financial transactions, and/or may serve any such ancillary functions. In some exemplary implementations, the local gaming systems 104 may be configured to serve locations such as airports, educational institutions or gaming convention centers etc.

It is to be appreciated here that the gaming architecture 100 is merely exemplary of a number of possible gaming network configurations, without limiting or deviating from the scope of the invention.

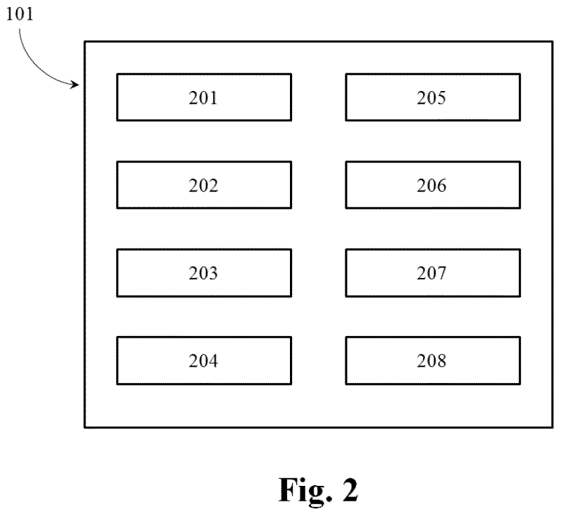

FIG. 2 is a block diagram schematically showing an exemplary configuration of the central gaming system 101 according to some implementations of the present invention.

The central gaming system 101 may include one or more processor modules 201, one or more data storage modules 202, one or more input/output modules 203, one or more memory modules 204, one or more networking interface 205, one or more internal networking module 206, at least one matchmaking module 207 and at least one collusion module 208.

It is to be appreciated by those skilled in the art that although FIG. 2 shows the various components of the central gaming system 101 as co-located, such components may be distributed geographically without deviating from the scope of the invention. Further, the central gaming system 101 according to some other implementations of the invention may include different components and/or configuration than those shown herein. Still further, the different components as shown here are merely functional components, and therefore, such functions may be performed by an integrated system, without deviating from the scope of the invention. In the same spirit, it is to be appreciated by those skilled in the art that different components as shown in FIG. 2 may employ shared resources, such as shared processor, memory, communications, networking or the like.

One or more processor modules 201 may be configured to run various algorithms, computer programs, gaming applications or other applications or programs to facilitate operations of the gaming architecture 100.

One or more data storage modules 202 may be configured to store gaming software and programs. Such gaming software and programs facilitate operations and execution of various virtual games. One or more data storage modules 202 may also store player data, including but not limited to, player IDs and demographic details. Further, one or more data storage modules 202 may store login and fingerprinting data for player terminals 103. The login and fingerprinting data may be used to identify the player terminals 103 through various parameters such as terminal ID, type, make and/or configuration, physical location, virtual location (for instance, IP address), OS version, or the like. Additionally, one or more data storage modules 202 may be configured to store play data, including game profiles, player profiles and terminal profiles.

A game profile may include all data relevant to a particular game, such as, but not limited to, number of game instances, total time and/or time per game, scorecards, in-game moves, game modes, number or percentage of players playing the game, and so on and so forth. The game profiles may also include real-time or near real-time data generated during live execution of virtual games.

A player profile may include all data arising out of a player's interaction with the central gaming system 101; such data indicative of the player's performance, skill, activity, preferences, and so on

A terminal profile may include all data arising out of a player terminal's interaction with the central gaming system 101; such data indicative of the type and/or quality of connection, ping rate, terminal IDs of historically matched player terminals, and so on.

It is to be appreciated here that a player profile successfully characterizes a player whereas a terminal profile successfully characterizes a player terminal. Hence, a player may swap a player terminal without affecting the player profile. Similarly, more than one player may participate using a single player terminal without affecting the terminal profile.

One or more data storage modules 202 may also be configured to store financial data that is indicative of the financial transactions, whether virtual or real, made through the gaming architecture 100. The financial data is indicative of the fee paid by players, losses, winnings, deposits, withdrawals, bonuses, referrals or any other type of financial transactions made.

It is to be appreciated here that such various categories of data may be stored in a single data storage module, or may be stored in multiple data storage modules, without deviating from the scope of the invention. Such multiple data storage modules may be co-located or distributed geographically. Further, some of these multiple data storage modules may be proprietary to third parties such as banks, fraud units, performance tracking platforms, betting platforms or the like.

One or more input/output modules 203 may include any interface commonly used to communicate with or operate the central gaming system 101, such as a display, keyboard, mouse, joystick, touchpad, microphone, camera, speakers, haptic device or other input-output techniques well known in the art. The central gaming system 101 may also be configured to be operated remotely through any communication network, including, but not limited to, the communications network 102.

One or more memory modules 204 may include any volatile and/or non-volatile memory such as, but not limited to, RAM, ROM, flash memory or the like well known in the art.

One or more networking interface 205 may be any physical and/or virtual networking interface, known in the art, configured to facilitate communication of the central gaming system 101 with the plurality of gaming terminals 103 through the communications network 102.

One or more internal networking module 206 may be any physical and/or virtual networking interface, known in the art, configured to facilitate communication between various components or modules of the central gaming system 101.

At least one matchmaking module 207 may be configured to identify potential matches, as opponents and/or teammates, for players intending to play an instance of a virtual game.

At least one collusion module 208 may be configured to predict and/or detect any collusive instances. The at least one collusion module 208 may retrieve, interpret and/or analyze data stored in one or more data storage modules 202. The at least one collusion module 208 may employ machine learning, deep learning, artificial intelligence, neural networks, GNN, heuristics, statistical processing or other data processing algorithms and techniques well known in the art.

At least one collusion module 208 may further be configured to generate and/or update a collusion profile. The collusion profile may be a player collusion profile, which is derived from a player profile. Alternatively, or in addition, the collusion profile may be a terminal collusion profile, which is derived from a player terminal profile. For ease of understanding, the player collusion profile and the terminal collusion profile are collectively termed here as the collusion profile for participant entity. The participant entity may be a player or a player terminal.

The collusion profile may be stored in one or more data storage modules 202 and is indicative of the participant entity's collusive behaviour. A participant entity's collusion profile indicates collusive actions undertaken by the participant entity in past instances of the game. Further, the collusion profile may also reflect a participant entity's probability of engaging in collusive action in future instances of the game.

A participant entity's collusion profile may also indicate the alliances made by the participant entity in the past or possible alliances that can be made in the future as well as information related to the co-colluders. As an example, if a first participant entity has colluded with a second participant entity in the past, or if probability of the first participant entity to collude with the second participant entity is higher than a threshold, in such cases, the collusion profile of the first participant entity may include a reference to the collusion profile of second participant entity and vice-versa. For ease of understanding, this is termed here as a shared segment between the collusion profiles of the first participant entity and the second participant entity. Hence, a shared segment constitutes of a reference from the collusion profile of one participant entity to the collusion profile of one other participant entity and vice versa. A single participant entity's collusion profile may have multiple shared segments, each shared segment representing a reference to the collusion profile of one other co-colluding participant entity.

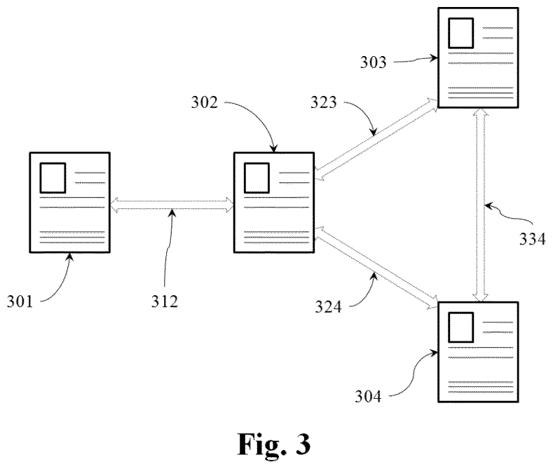

FIG. 3 is a graphical representation of multiple shared segments as shall be explained hereunder.

Continuing with the previous example, assuming that the first participant entity and second participant entity are co-colluders and similarly the second participant entity, a third participant entity and a fourth participant entity are also co-colluders, then the following shall be the representation of the shared segments:

For the first participant entity's collusion profile (301)—One common segment (312), with the second participant entity's collusion profile (302).

For the second participant entity's collusion profile (302)—Three common segments (312,323,324), one each with the first, the third and the fourth participant entity's collusion profiles (301,303,304) respectively.

For the third participant entity's collusion profile (303)—Two common segments (323,334), one each with the second and the fourth participant entity's collusion profiles (302,304) respectively.

For the fourth participant entity's collusion profile (304)—Two common segments (324,334), one each with the second and the third participant entity's collusion profiles (302,303) respectively.

It is to be appreciated here that the term shared segment is in no way limiting, and only serves representational purposes for the ease of understanding.

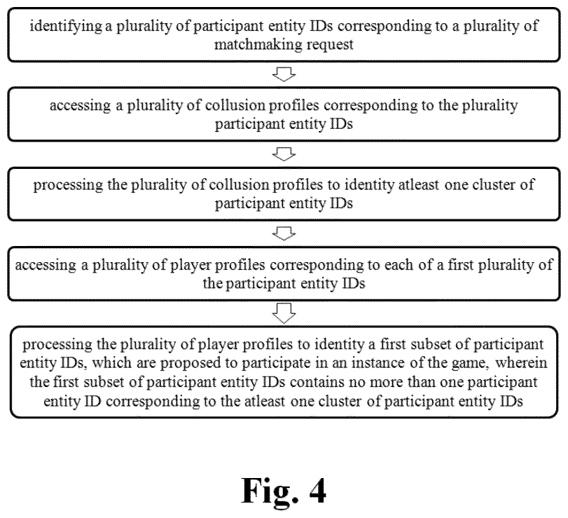

Referring now to FIG. 4, there is shown a flowchart illustrating a method of preventing fraud by matching players intelligently.

At any instance, there exists a plurality of players intending to play a multiplayer online game, through their respective player terminals 103 which are in communication with the central gaming system 101 through the communications network 102. Each of these players may make a request to play the game through their respective player terminals 103 which transmits these requests to the central gaming system 101. Any such request may include data corresponding to a player's identity, a player terminal's identity, a requested game-type, lobby details, among others. For ease of understanding, the player's identity and the player terminal's identity are hereby collectively referred to as participant entity's identity. The game-type may identify the type and/or the category of the game, such as but not limited to, board game, card game etc. The game-type may also identify the specific type of game, such as but not limited to, poker, rummy, carom or the like. The lobby details may correspond to the fee paid by a player to participate in a game. The lobby details may also be indicative of the amount involved in financial transactions (real or virtual), including any in-game purchases, proposed or required to be made by the player during gameplay.

At the central gaming system 101, each of these requests may be routed to the matchmaking module 207 for setting up potential matches between the plurality of participant entities. The requests may be time-stamped in order for the matchmaking module 207 to process them linearly (FIFO), or the matchmaking module 207 may gather a plurality of requests for batch processing. In some implementations, the matchmaking module 207 may be configured to gather a minimum number of requests. In other implementations, the matchmaking module 207 may be configured to wait for a required time to gather the requests. In still other implementations, the matchmaking module 207 may be configured to dynamically adjust between linear or batch processing.

At the matchmaking module 207, each received request is processed and the data accompanying the request is identified. Corresponding to the identified data, each request is categorized according to at least one of the game-type and/or the lobby details. As such, every request gets categorized by game-type (such as poker, rummy, racing etc.) and/or lobby details (free to play, higher fee, more and/or costlier in-game purchases etc.). In any such category, matchmaking module 207 collates all respective requests in order to process the same.

In an embodiment of the invention, the matchmaking module 207 identifies, for each request, a participant entity ID from the data accompanying the request.

Corresponding to each participant entity ID, the collusion module 208 may access a collusion profile. The collusion module 208 may retrieve the collusion profiles from one or more data storage modules 202. Alternatively, or in combination, the collusion module may dynamically generate the collusion profiles by accessing the data stored in one or more data storage modules 202.

The collusion module 208 may process these collusion profiles and identify any shared segments that are indicated within these collusion profiles. Based on the identified shared segments, collusion module 208 may identify at least a first cluster of participant entity IDs. The first cluster of participant entity IDs may correspond to participant entities whose collusion profiles indicate commonly shared segments.

In continuation with the previous example as described in FIG. 3, the first participant entity ID and the second participant entity ID may form a first cluster of participant entity IDs. Similarly, the second participant ID, the third participant ID and the fourth participant ID may form a second cluster of participant entity IDs.

Consequently, the participant entity IDs whose collusion profiles do not indicate any shared segment may not be categorized in any cluster.

Corresponding to each of a plurality of participant entity IDs, the matchmaking module 207 may retrieve a player profile from one or more data storage modules 202.

In some implementations, the matchmaking module 207 may retrieve the player profiles corresponding to each of the participant entity IDs.

In some other implementations, the matchmaking module 207 may retrieve the player profiles corresponding to only a few of the participant entity IDs. As an example, the matchmaking module 207 may not retrieve the player profile for at least one of the participant entity ID belonging to a first cluster of participant entity IDs.

Matchmaking module 207 may process each player profile and identify at least one proposed match. The at least one proposed match consists of a plurality of participant entities that are selected to participate together in a single instance of the game. At least one proposed match may be of type 1vs1, 2vs2, 3vs3 and so on. Also, at least one proposed match may be of the type where the plurality of participant entities all participates as opponents, such as in games like rummy, poker, carom, or the like.

Through processing the player profiles, the matchmaking module 207 identifies players' skill levels, preferences and/or historical data. The matchmaking module 207 may then employ various matchmaking techniques and algorithms to identify at least one proposed match. Alternatively, the matchmaking module may identify the at least one proposed match by random grouping or pairing.

While identifying at least one proposed match, the matchmaking module 207 may select not more than one participant entity ID from a single cluster of participant entity IDs.

In continuation with the previous example as described in FIG. 3, an exemplary proposed match may comprise of at most one participant entity ID from the first cluster consisting of the first participant entity ID and the second participant entity ID. Similarly, another exemplary proposed match may comprise of at most one participant entity ID from the second cluster consisting of the second participant ID, the third participant ID and the fourth participant ID. It is to be appreciated here that matchmaking module 207 may not place any constraint on selecting at most one participant entity ID from the different clusters.

As such, in continuation with the previous example as described in FIG. 3, an exemplary proposed match may comprise of at most one participant entity ID from the first cluster and at most one participant entity ID from the second cluster.

In an alternate implementation, the matchmaking module 207 may identify a collusion score for at least one participant entity ID in the first cluster of participant entity IDs. The matchmaking module 207 may retrieve the collusion score stored in one or more data storage modules 202. Alternatively, the collusion score may be generated dynamically in real-time or near real-time by one or more processor modules 201. One or more processor modules 201 may analyze or process the data stored in one or more data storage modules 202 to compute the collusion score.

One or more processor modules 201 may compare the collusion score with a threshold score. The threshold score may be pre-stored in one or more data storage modules 202 or it may be computed by one or more processor modules 201 in real-time. In case the collusion score is greater than the threshold score, one or more processor module 201 may restrict the at least one participant entity ID in the first cluster of participant entity IDs from being matched by the matchmaking module 207.

Through the above exemplary implementations, the matchmaking module 207 may ensure that players who have a high probability of colluding with each other do not play in the same instance of the game. Further, the matchmaking module 207 may also ensure that players who have a very high probability of colluding are restricted from participating in an instance of the game.

The disclosure is operational with numerous other general purpose or special purpose computing system environments or configurations. Examples of well-known computing systems, environments, and/or configurations that may be suitable for use with the disclosure include, but are not limited to, personal computers, server computers, handheld or laptop devices, multiprocessor systems, microprocessor-based systems, set top boxes, programmable consumer electronics, network PCs, minicomputers, mainframe computers, and distributed computing environments that include any of the above systems or devices, and the like.

As used herein, the wording “module” serves only as a representation of the functional aspect, and should not be construed as limiting to only physical or tangible systems or components.

1. A method of matching players requesting to play a virtual game, the method comprising:
receiving a plurality of matchmaking requests, each of the plurality of matchmaking requests signaling an intent of a player to play the virtual game;
identifying, by one or more processing modules 201, a participating entity ID for each of the plurality of matchmaking requests;
accessing by one or more processing modules 201, a collusion profile for each participant entity ID;
wherein the method comprises,
processing, by the one or more processing modules 201, each collusion profiles for each participant entity ID to identify at least one cluster of participant entity IDs;
accessing, by the one or more processing modules 201, a plurality of player profiles corresponding to each of a first plurality of the participant entity IDs of the at least one cluster of participant entity IDs; and
processing, by the one or more processing modules 201, the plurality of player profiles to identify a first subset of participant entity IDs, for generating a collusion score, proposed to participate in an instance of the game, thereby enabling matching of the players based on the collusion score to play the game, wherein
the first subset of participant entity IDs comprises at least one participant entity ID corresponding to the at least one cluster of participant entity IDs.

2. The method according to claim 1, wherein, the method comprises processing the each collusion profile for each participant ID to identify a plurality of clusters of participant entity IDs.

3. The method according to claim 2, wherein, the method comprises processing the each collusion profile to identify a plurality of participant entity IDs which are not categorized in any of the plurality of clusters of participant entity IDs.

4. The method according to claim 2, wherein, the first subset of participant entity IDs contains at least one participant ID which is not categorized in any of the plurality of clusters of participant entity IDs.

5. The method according to claim 1 further comprising,
identifying the collusion score for at least one participant entity ID in the at least one cluster of participant entity IDs;
comparing the collusion score with a threshold score; and
restricting the at least one participant entity ID, based on the comparison of the collusion score and the threshold score, from participating in an instance of the game.

6. A system for matching players requesting to play a virtual game, the system comprising:
one or more processing modules 201;
one or more data storage modules 202, operatively coupled to the one or more processing modules 201, wherein the one or more data storage modules 202 are configured to store at least one of,
a plurality of participant entity IDs,
a plurality collusion profiles, each collusion profile corresponding to each participant entity ID from the plurality of participant entity IDs,
a plurality of player profiles, each player profile corresponding to one participant entity ID of the plurality of participant entity IDs, and
at least one memory module 204 operatively coupled to the one or more processing modules 201, the at least one memory module 204 stores instructions which, when executed by the one or more processing modules 201, causes the one or more processing modules 201 to,
identify a participating entity ID for each of a plurality of matchmaking requests;
access each collusion profile corresponding to the identified participant entity IDs, wherein each collusion profile corresponds to one of the identified participant entity IDs;
wherein the one or more processing modules 201 is further configured to,
process each collusion profile to identify at least one cluster of participant entity IDs;
access a plurality of player profiles corresponding to each of a first plurality of the participant entity IDs of the at least one cluster of participant entity IDs; and
process the plurality of player profiles to identify a first subset of participant entity IDs, which are proposed to participate in an instance of the game for generating a collusion score, thereby enabling matching of the players based on the collusion score to play the game, wherein
the first subset of participant entity IDs comprises at least one participant entity ID corresponding to the at least one cluster of participant entity IDs.
